(19) United States
(12) Patent Application Publication
(10) Pub. No.: US 2011/0283233 A1
(43) Pub. Date: Nov. 17, 2011

(54) CART TRACKING SYSTEM

(76) Inventors: Robert Lee Martin, JR., Pleasant Prairie, WI (US); Zachary Thomas Martin, Whitefish Bay, WI (US); Matthew Lester Dannenfeldt, Libertyville, IL (US); Jeremy Hector, Kenosha, WI (US); Dustin Joseph DePanfilis, Baltimore, MD (US); Joe Delaney, Brewerton, NY (US)

(21) Appl. No.: 13/109,603

(22) Filed: May 17, 2011

Related U.S. Application Data
(60) Provisional application No. 61/345,233, filed on May 17, 2010.

(51) Int. Cl. G06F 3/048

(52) U.S. Cl. 715/810

(57) ABSTRACT

A system and method for distributing or auditing carts on collection routes includes the ability to add addresses to the route from a handheld device carried on the route. Additionally, the user can add a house to a known address where there was previously not a house. Additionally, the user can add an identifier (such as an RFID tag) to an existing cart along the route.

This claims the priority to U.S. Provisional Application Ser. No. 61/345,233 filed May 17, 2010.

### BACKGROUND

This invention generally relates to carts and, more particularly, to trackable carts.

Carts for moving recyclables, trash, and other items are well known. Some municipalities provide residents with carts, especially large, roll-out recyclable carts. The residents load the cart with recyclables and then roll filled carts to a collection location. A recyclable truck next maneuvers to a position adjacent the collection location. A lift arm extending from the recyclable truck lifts and rotates a filled cart to pour the recyclables into the recyclable truck. Moving recyclables to the truck in this manner is often referred to as “tipping” the cart. Once emptied, the lift arm returns the cart to the collection location.

Carts may include identifiers that facilitate associating the cart with a particular location. The identifiers assist during waste collection billing or when tracking recycling participation, such as billing the resident for emptying recyclables from their carts, for example. Adding identifiers to recyclable carts complicates the cart manufacturing process.

### SUMMARY

This invention generally relates to carts and, more particularly, to trackable carts. This invention provides methods for distributing or auditing carts along a route. In one method, a list of addresses along a selected route is displayed in response to a user input selecting the selected route from a plurality of available routes. Information about a selected address from the list of addresses is displayed in response to a user input selecting the selected address, the information including a requested cart type. A serial number of a cart to be delivered to the selected address is received and associated with the selected address.

According to another method disclosed herein, if the person distributing carts along the route encounters an address that is not found in the list of addresses, the person can add the address to the list of addresses in the handheld database. The new address is then associated with the serial number of the cart delivered to the new address.

### BRIEF DESCRIPTION OF THE DRAWINGS

FIG. 1 is a perspective view of an example roll-out recyclable cart;

FIG. 2 is a perspective view of a recyclable truck tipping the FIG. 1 roll-out recyclable cart;

FIG. 3 is a front view of a portion of the lift arm extending from the FIG. 2 roll-out recyclable cart;

FIG. 4 schematically shows an example roll-out cart tracking system for tracking the FIG. 1 roll-out recyclable cart;

FIG. 5 is a perspective, partial exploded view of another example roll-out recyclable cart;

FIG. 6 is a perspective view of an example fixture assembly for associating a cart with a non-optical identifier;

FIG. 7 shows the FIG. 5 cart within the FIG. 6 fixture;

FIG. 8 shows an example display from the FIG. 6 fixture; and

FIG. 9 displays an initial screen of a handheld device when used in distributing the carts on a route or auditing a route.

FIG. 10 displays a route selection or address entry screen.

FIG. 11 displays a route address list screen.

FIG. 12 displays an address information screen.

FIG. 13 displays an “undeliverable cart” screen.

FIG. 14 displays an “add address” screen.

FIG. 15 displays an “add house” screen.

### DETAILED DESCRIPTION OF THE PREFERRED EMBODIMENT

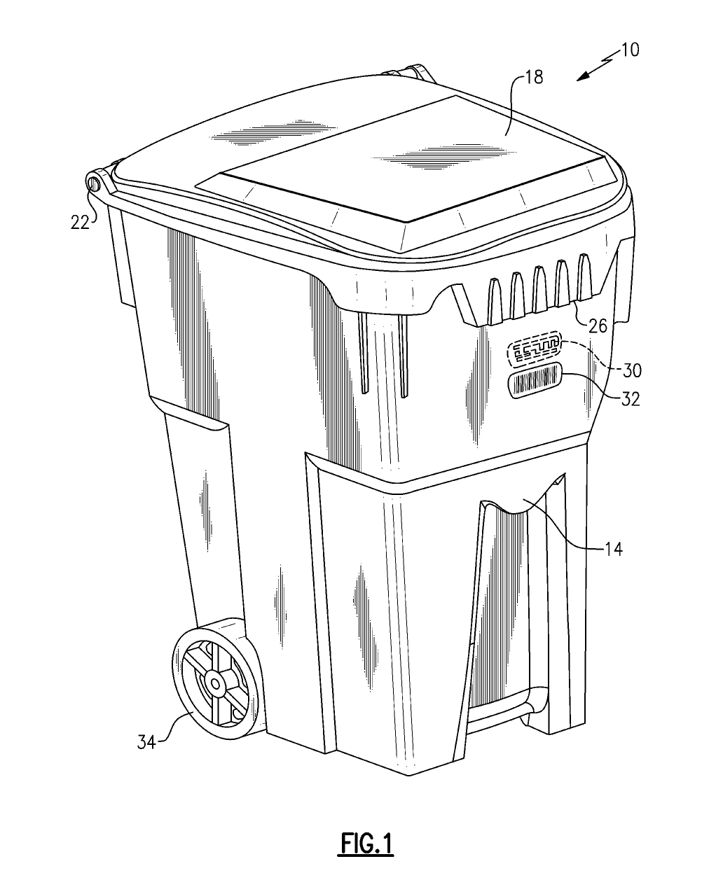

FIG. 1 illustrates an example roll-out recyclable cart 10 having a hollow body portion 14 coverable with a lid member 18. A hinge member 22 connects the lid member 18 to the hollow body portion 14. The roll-out recyclable cart 10 includes handle members 26 and wheels 34 for manipulating the position of the roll-out recyclable cart 10. Other examples include using the roll-out recyclable cart 10 for collecting other items, such as trash, non-recyclable items, or leaves.

The roll-out recyclable cart 10 includes a non-optical identifier 30 secured to an exterior surface of the roll-out recyclable cart 10. In this example, the non-optical identifier 30 is a radio frequency identification (RFID) tag. The roll-out recyclable cart 10 also includes an optical identifier 32, such as a barcode sticker, secured to an exterior surface of the roll-out recyclable cart 10. The lid member 18 and the hollow body portion 14 are typically injection molded from a polymer material such as High Density Polyethylene (HDPE). The non-optical identifier 30 is in-molded during the injection molding process to secure the non-optical identifier 30 to the roll-out recyclable cart 10, and the optical identifier 32 is secured to an outer surface of the hollow body portion 14 using adhesive, for example.

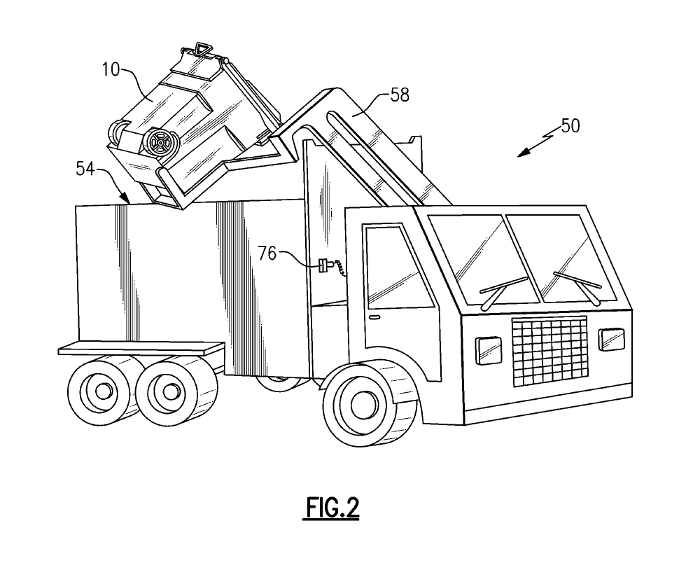

As shown in FIG. 2, a lift arm 58 extending from a recyclable truck 50 lifts and tips the roll-out recyclable cart 10 to empty recyclables from the roll-out recyclable cart into the recyclable bin 54. A pair of forks 62 extending from the lift arm 58 receive the roll-out recyclable cart 10 and maintain the position of the roll-out recyclable cart 10 relative to the lift arm 58 while lifting the roll-out recyclable cart 10 over the recyclable bin 54. After recyclables move from the roll-out recyclable cart 10 into the recyclable bin 54, the lift arm 58 returns the roll-out recyclable cart 10 to the collection location position adjacent the recyclable truck 50. As known, a recyclable truck operator manipulates the roll-out recyclable cart 10 between a received position within the forks 62 and the collection location.

FIG. 3 illustrates a portion of the lift arm 58 having the forks 62 for receiving the roll-out recyclable cart 10. A reader 74 mounts to a portion of the lift arm 58. When the roll-out recyclable cart 10 of FIG. 2 is received within the forks 62 of the lift arm 58, the non-optical identifier 30 generally aligns with the reader 74. In such a position, the reader 74 communicates with the non-optical identifier 30 in a known manner. For example, the reader 74 may transmit a radio frequency signal to the non-optical identifier 30, which returns a signal to the reader 74 containing identification information. As discussed previously, the example non-optical identifier 30 in this example is a passive RFID tag, which relies on the radio frequency signal from the reader 74 to provide the necessary power to the non-optical identifier 30 for transmitting a response back to the reader 74. Other examples include mounting the reader 74 to the recyclable bin 54.

The non-optical identifier 30 contains identification information corresponding to the particular roll-out recyclable cart 10. For example, the non-optical identifier 30 includes an alphanumeric identification code (ID) associated with the roll-out recyclable cart 10. In this example, the information on the non-optical identifier 30 is set or established during assembly of the roll-out recyclable cart 10. The recyclable truck 50 collects information about the tipped roll-out recyclable cart 10 through the non-optical identifier 30. Although described in this example as an RFID tag, those skilled in the art and having the benefit of this disclosure may understand other types of non-optical identifiers for storing such information.

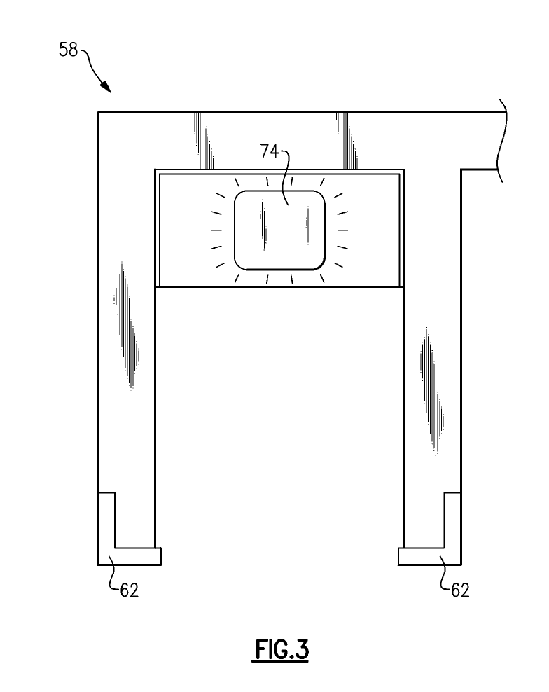

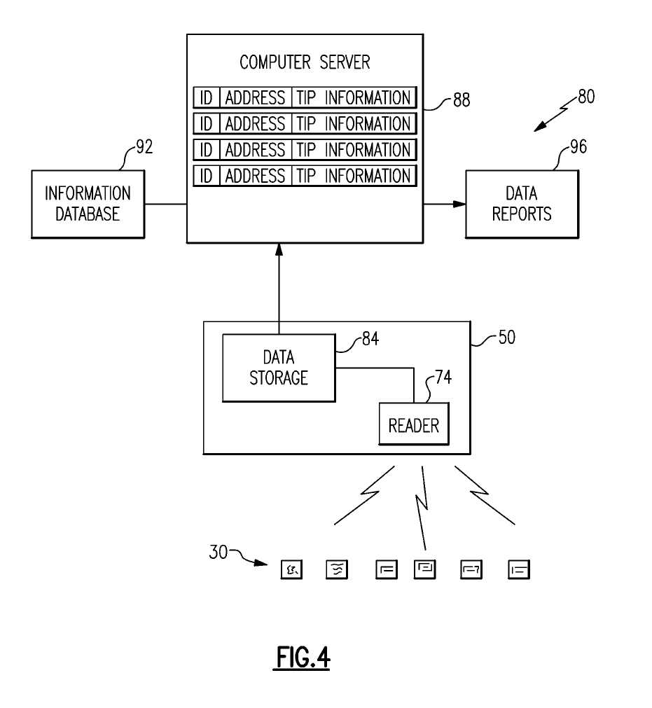

FIG. 4 schematically illustrates an example system 80 utilizing the roll-out recyclable cart 10 of FIG. 1 with the non-optical identifier 30. The system 80 collects and stores data within data storage 84 from at least one non-optical identifier 30 using the reader 74. This data collection occurs within the recyclable truck 50 and includes saving identification from more than one non-optical identifier 30. Example information may include recording the data and time of the tip, GPS data, and recording the ID of the tipped roll-out recyclable cart 10 obtained from the non-optical identifier 30.

The data within the data storage 84 communicates to a computer server 88. Communicating the data to the computer server 88 may take place after the recyclable truck 50 returns from collecting recyclables on a particular route or after filling the recyclable bin 54 with recyclables. In another example, the recyclable truck 50 communicates collected data wirelessly after each tip, or periodically.

The computer server 88 associates the ID, date, and time information with further information by communicating with an information database 92. The ID from the non-optical identifier 30 associates the roll-out recyclable cart 10 with other information in the database 92, such as an address corresponding to a resident utilizing the roll-out recyclable cart 10. Thus, the non-optical identifier 30 permits the computer server 88 to associate the address for the roll-out recyclable cart 10 with date and time information about the tip. The database 92 may also include mold date and distribution date. In such an example, the computer server 88 obtains necessary information directly from the non-optical identifier 30 rather than associating the ID with data in the information database 92

The computer server 88 generates data reports 96 using the associations from the computer server 88. Example data reports 96 generate recyclable collection bills for customers based on the number of tips associated with their roll-out recyclable cart 10. Other examples, such as when using another type of cart, also generate collection bills based on the number of tips. Other example data reports 96 plan routes for the recyclable truck 50, which are optimized or otherwise modified based on the number of tips associated with a particular area. That is, the recyclable truck 50 would plan a shorter route if, over time, the smaller route resulted in as many tips, and therefore as much recyclables, as another larger route. Thus, the system 80 estimates future volumes of recyclables based on the past number of tips of the roll-out recyclable cart 10 at particular locations.

Other examples may include providing a website for customers to track their roll-out recyclable cart 10 using ID from the non-optical identifier 30. In such an example, a resident logs on to an internet website, provides their ID, and tracks progress of repairs to their roll-out recyclable cart 10, for example. Recyclable truck weight 50 and average weight per stop are also reported on the internet website or elsewhere in some examples.

The non-optical identifier 30 is sometimes added to the roll-out recyclable cart 10 after manufacturing, rather than as a manufacturing step. For example, referring to FIG. 5, another example roll-out recyclable cart 10a includes a hinge member 22a that defines a chamber 100, here a cylindrical chamber. In this example, the hinge member 22a connects to a handle section 102 used to manipulate the position of the roll-out recyclable cart 10a. An optical identifier 32a is secured to an outer surface of the roll-out recyclable cart 10a during manufacturing.

In this example, the hinge member 22a includes portions molded with both the hollow body portion 14a and the lid member 18a, while the handle section 102 is molded together with the hollow body portion 14a. Removing a pin 104 from the hinge member 22a along a hinge axis X permits separating the lid member 18a from the hollow body portion 14a, and exposes the chamber 100, which extends along the hinge axis 104 through the hinge member 22a and the handle section 102. In this example, the chamber 100 stores a non-optical identifier 108, here a flexible RFID tag. The pin 104 stores the non-optical identifier 108 in another example.

The walls of the chamber 100 protect the non-optical identifier 108 during use of the roll-out recyclable cart 10a. Further, utilizing the chamber 100 to hold the non-optical identifier 108 facilitates adding the non-optical identifier 108 to the roll-out recyclable cart 10a, even after manufacturing the roll-out recyclable cart 10a. If the non-optical identifier 108 is added later, or otherwise lacks an association with the roll-out recyclable cart 10, the non-optical identifier 108 may need to be associated with the optical identifier 32, the roll-out recyclable cart 10, or both.

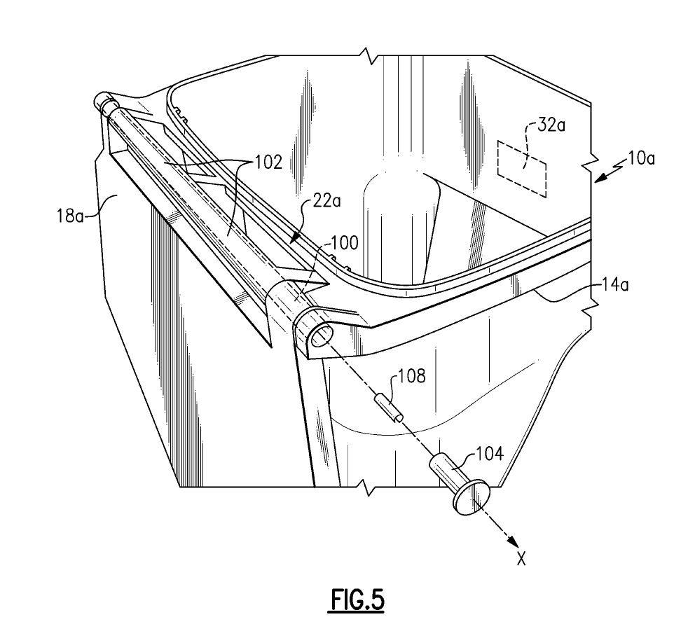

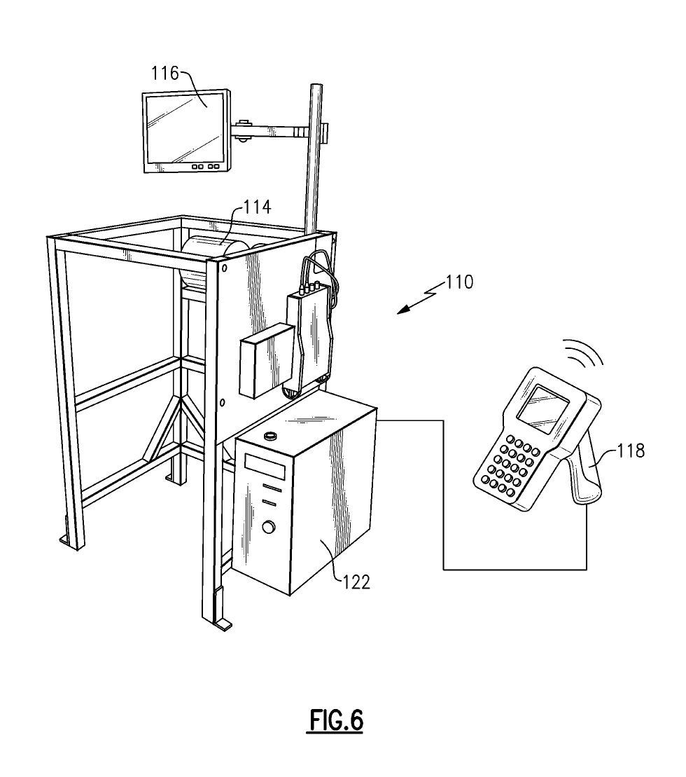

Referring to FIG. 6 with continuing reference to FIG. 5, a fixture 110 includes a non-optical scanner 114 for reading the non-optical identifier 108 and a handheld device 118 with a display (touchscreen), a user input device such as keys and/or the touchscreen, and an optical reader (barcode scanner) for reading the optical identifier 32. The handheld device 118 includes a processor, memory (or other storage for the route databases and suitable programming), wireless connectivity (wi-fi, or cell network, or Bluetooth, or similar), and optionally GPS or other location-determining hardware. The handheld device 118 may include an RFID scanner and barcode scanner (non-optical scanner and optical reader). Other examples include reading the non-optical identifier 108 and the optical identifier 32 with a single handheld scanner. A display 116 displays scanning results and user menus for example.

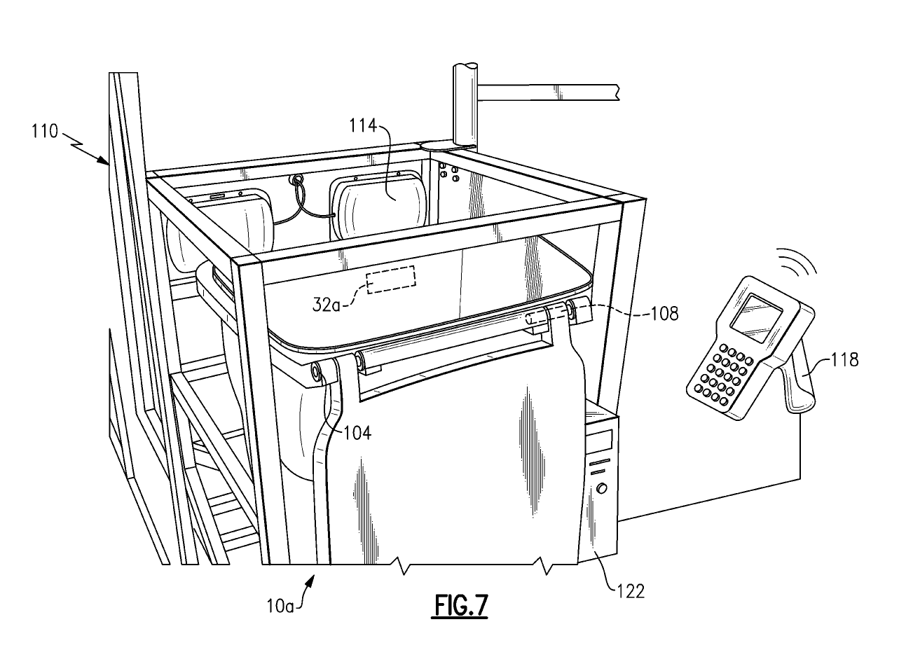

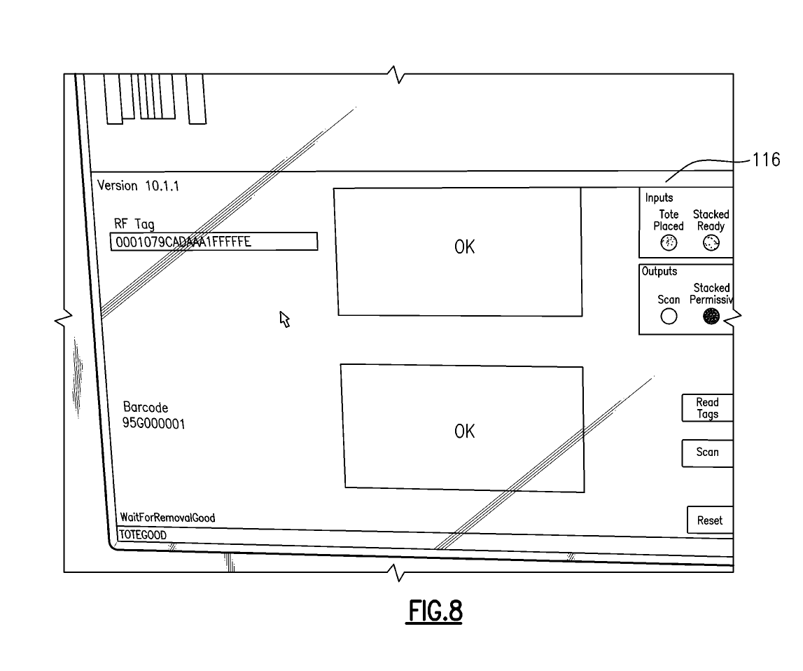

Referring to FIG. 7, the roll-out recyclable is moved within the fixture 110 to properly position the non-optical identifier 108 and the optical identifier 32 for scanning. A general purpose computer 122 is used for associating the optical identifier 32 with the non-optical identifier 108. The fixture 110 also verifies presence of the optical identifier 32 and the non-optical identifier 108. FIG. 8 illustrates a screen shot from the display 116 showing an example reading from the non-optical scanner 114 and the handheld device 118.

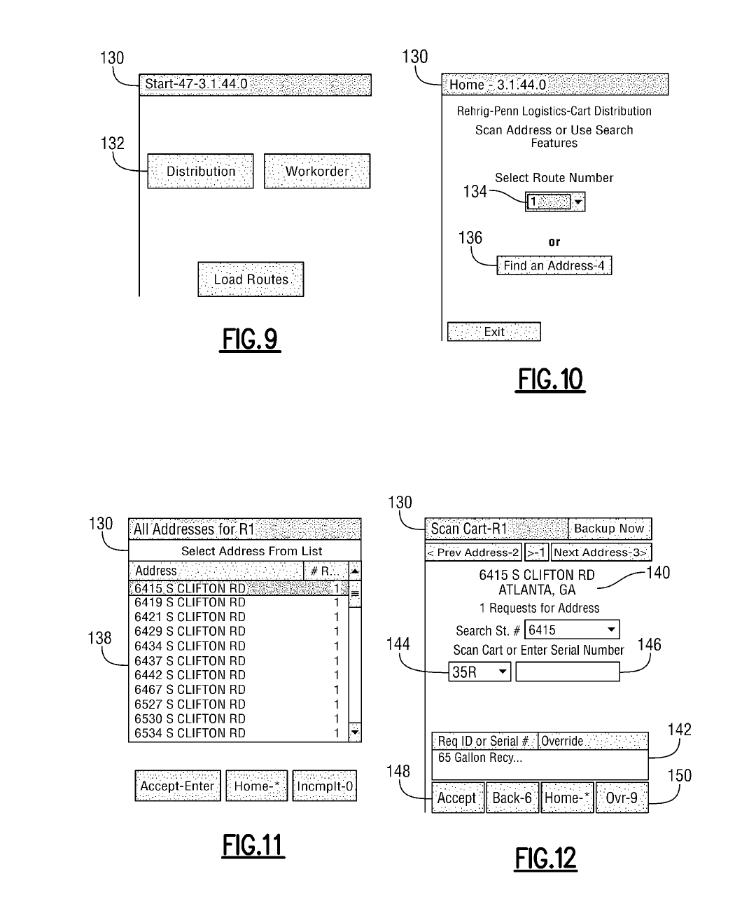

FIGS. 9-15 display the screen 130 of a handheld device 118 when used in distributing the carts 10 on a route or auditing a route. In FIG. 9, the screen 130 displays the ability for the user to selection a Distribution button 132, which then prompts the options shown in FIG. 10 including a pull down Route Number menu 134 or an address button 136 to enter an address directly. If the user chooses a Route Number in FIG. 10, the addresses for the selected route are displayed in a route address list 138 as shown in FIG. 11. The user selects one of the addresses from the route address list 138, which causes the screen 130 to display the information shown in FIG. 12, including the selected address 140, the type of cart requested 142 at that address, a pull-down menu 144 of available cart types and a serial number field 146. The user selects the requested cart 10 from the distribution truck and either scans the optical identifier 32 with the handheld device 118 to automatically put the serial number into serial number field 146, or scans the non-optical identifier 108 (RFID) with the handheld device 118 to automatically put the serial number into serial number field 146, or the user types in the serial number manually into serial number field 146. The user selects the “accept” button 148 to save the entry. Upon synchronization with the server 88 (e.g. via internet or when the handheld device 118 is docked with a computer having access to the server 88), the serial number, cart type, etc of the cart 10 delivered to the address is then associated with that address in the database 92.

Referring again to FIG. 12, if the user is unable to deliver the requested cart 10 for some reason, the user selects the override button 150. This prompts the display of FIG. 13, which includes a list 152 of potential reasons the cart 10 could not be delivered or scanned, including: no access to property, driver could not locate address, cart type not on truck, resident refused delivery, carts already delivered, the house is uninhabitable, burned out structure, road blocked, delivered—not scanned, cart scanned to wrong address (allows a user to clear a serial number scanned to the wrong address—after selection, the user can navigate to the correct address and re-scan).

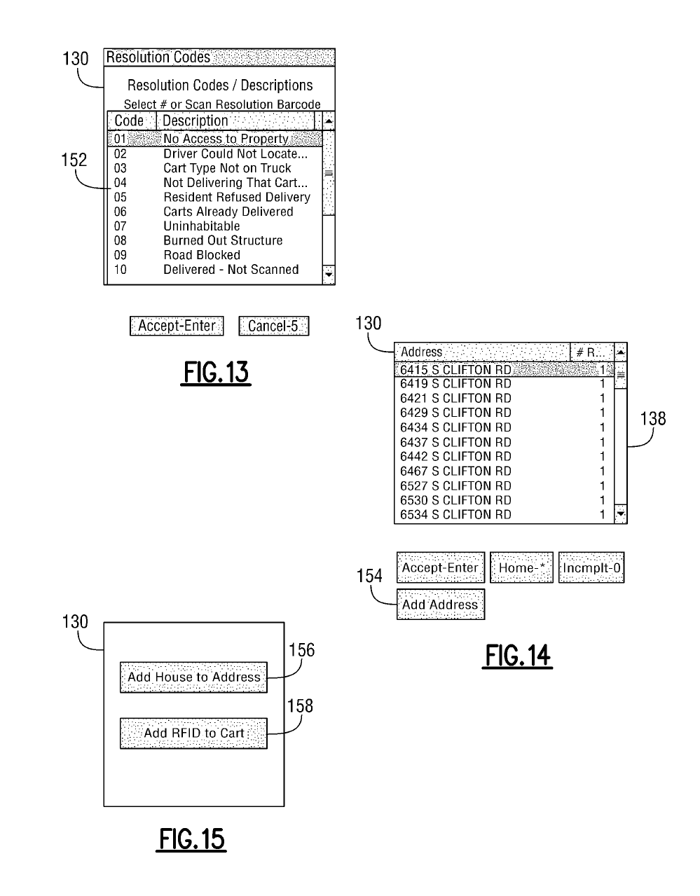

In FIG. 14, with the list of addresses 138 displayed, the user can select an “Add Address” button 154 if the user encounters an address on the street that is not in the database. The user can then type in the street address, sync it with a gps address and/or deliver a cart to the new address. All of this information is loaded to the database 92 when the handheld unit 118 is synchronized.

In FIG. 15, the user can select an “Add House to Address” button 156, which permits the user to indicate a new house on an address which was previously indicated as a vacant lot. Again, the user can then deliver a cart 10 to the new house. This information is synchronized back to the database 92.

Also in FIG. 15, the user can select an “Add RFID to Cart” button 158, which permits the user to install an RFID tag on an existing cart lacking one (such as an older cart). The user installs the RFID tag in the field, then scans it to associate it with the house address. This information is synchronized back to the database 92.

Although a preferred embodiment has been disclosed, a worker of ordinary skill in this art would recognize that certain modifications would come within the scope of this invention. For example, although many features are disclosed as being performed on the handheld device, these features could be performed on a computer in the delivery truck, on a laptop computer, etc. For that reason, the following claims should be studied to determine the true scope and content of this invention.

What is claimed is:

1. A method for distributing carts along a route including the steps of:
a) displaying a list of addresses along a selected route in response to a user input selecting the selected route from a plurality of available routes;
b) displaying information about a selected address from the list of addresses in response to a user input selecting the selected address, the information including a requested cart type; and
c) receiving a serial number of a cart to be delivered to the selected address and associating the serial number with the selected address.

2. The method of claim 1 further including the steps of:
d) in response to a user input indicating that delivery could not occur, displaying a list of potential reasons that the delivery could not occur; and
e) receiving a user input selecting a selected reason from the plurality of reasons that the delivery could not occur and associating the selected reason with the selected address.

3. The method of claim 2 further including the steps of:
f) receiving a user input indicating the cart was associated with a wrong address; and
g) in response to said step f), clearing the serial number from the selected address.

4. The method of claim 1 further including the steps of:
d) receiving a user input requesting to add a new address not in the list of addresses;
e) receiving the new address and adding the new address to the list of addresses along the selected route; and
f) associating the serial number of the cart with the new address.

5. The method of claim 1 further including the steps of:
d) receiving a user input requesting to add a house to a vacant address in the list of addresses along the selected route;
e) adding an indication of the house on the vacant address on the list of addresses along the selected route; and
f) associating the serial number of the cart with the address.

6. The method of claim 1 further including the steps of:
d) receiving a user input requesting to add an identifier to a cart at the selected address;
e) receiving a serial number from the identifier after said step d); and
f) associating the serial number with the cart at the selected address.

7. The method of claim 1 further including the step of synchronizing the serial number to a remote server.

8. The method of claim 1 wherein said steps a-c are performed on a handheld device, said method further including the step of synchronizing the serial number and new address from the handheld device to a remote server.

9. A method for distributing carts along a route including the steps of:
a) displaying a list of addresses along a selected route in response to a user input selecting the selected route from a plurality of available routes;
b) receiving a user input requesting to add a new address not in the list of addresses;
c) receiving the new address and adding the new address to the list of addresses along the selected route;
d) receiving a serial number of a cart to be delivered to the new address; and
e) associating the serial number of the cart with the new address.

10. The method of claim 9 further including the step of synchronizing the serial number and new address to a remote server.

11. The method of claim 9 further including the steps of:
f) receiving a user input requesting to add an identifier to the cart at the selected address before said step d);
g) during said step d) receiving the serial number from the identifier after said step f); and
h) associating the serial number with the cart at the selected address.

12. The method of claim 11 wherein said steps a-h are performed on a handheld device, said method further including the step of synchronizing the serial number and address from the handheld device to a remote server.

13. A method for auditing carts along a route including the steps of:
a) displaying a list of addresses along a selected route in response to a user input selecting the selected route from a plurality of available routes;
b) receiving a user input selecting an address from the list of addresses;
c) receiving a user input requesting to add an identifier to a cart already at the selected address;
d) receiving a serial number from the identifier;
e) associating the serial number with the cart already at the selected address.
f) associating the serial number of the cart with the new address.

14. The method of claim 13 further including the step of synchronizing the serial number and new address to a remote server.

15. The method of claim 13 wherein said steps a-f are performed on a handheld device, said method further including the step of synchronizing the serial number and new address from the handheld device to a remote server.

16. A system for distributing carts along a route including:
a handheld device including a user input device and a display, the handheld device configured to display on the display a list of addresses along a selected route in response to selection of the selected route from a plurality of available routes via the user input device, the handheld device displaying on the display information about a selected address from the list of addresses in response to a user input selecting the selected address via the user input device, the information including a requested cart type, the handheld device configured to receive a serial number of a cart to be delivered to the selected address and to associate the serial number with the selected address; and
a remote server, the handheld device configured to synchronize the selected address and serial number to the remote server.

17. The system of claim 16 wherein the handheld device is configured to display a list of potential reasons that the delivery could not occur on the display in response to a user input on the user input device indicating that delivery could not occur, the user input device configured to receive a user input via the user input device selecting a selected reason from the plurality of reasons that the delivery could not occur and associating the selected reason with the selected address.

18. The system of claim 17 wherein the handheld device is configured to receive a user input via the user input device indicating the cart was associated with a wrong address, the handheld device configured to clear the serial number from the selected address in response to the user input device indicating the cart was associated with a wrong address.

19. The system of claim 16 wherein the handheld device is configured to receive via the user input device a user input requesting to add a new address not in the list of addresses, the handheld device being configured to receive the new address and adding the new address to the list of addresses along the selected route, the handheld device further configured to associate the serial number of the cart with the new address.

20. The system of claim 16 wherein the handheld device is configured to receive via the user input device a user input requesting to add a house to a vacant address in the list of addresses along the selected route, the handheld device configured to add an indication of the house on the vacant address on the list of addresses along the selected route and to associate the serial number of the cart with the address.

21. The system of claim 16 wherein the handheld device is configured to receive via the user input device a user input requesting to add an identifier to a cart at the selected address, to receive a serial number from the identifier, and to associate the serial number with the cart at the selected address.

22. The system of claim 16 further including a plurality of carts including the cart to be delivered to the selected address, each of the plurality of carts including a non-optical identifier which can be scanned by the handheld device to receive the serial number of the cart.

23. The system of claim 16 further including a plurality of carts including the cart to be delivered to the selected address, each of the plurality of carts including an optical identifier which can be scanned by the handheld device to receive the serial number of the cart.
